(19) United States
(12) Patent Application Publication
(10) Pub. No.: US 2011/0203966 A1
(43) Pub. Date: Aug. 25, 2011

(54) Housing and Method for Assembling the Housing

(76) Inventor: Stefan Otzen, Munchen (DE)

(21) Appl. No.: 13/126,763

(22) PCT Filed: Oct. 28, 2008
(86) PCT No.: PCT/EP08/64583

§ 371 Date: Apr. 28, 2011

(51) Int. Cl. B65D 85/00; B23P 19/00

(52) U.S. Cl. 206/706; 29/428

(57) ABSTRACT

A housing for accommodating a circuit board, comprising a first housing part having a first floor and a first side wall, and a second housing part having a second floor and a second side wall. The first housing part has a catch protrusion in an area of at least one corner, said protrusion protruding past the first side wall. The second housing part has a catch recess in the area of at least one corner.

The invention relates to a housing and to a method for the assembly thereof and to an assembly device for such housings.

Electronic ballasts are often arranged in housings, in particular plastic housings. These housings have a catching closure mechanism. It is, for example, known for a two-part housing to be joined together in a catching manner.

In this known case, the catching closure mechanism and the assembly of the housing have a detrimental impact on the circuit board arranged in the housing: for example, the catching closure mechanism often needs space which cannot be filled by the circuit board or by the devices provided on it. Assembly also necessitates a temporary bending of the housing parts, so in this regard the circuit board and/or the devices present on it have to leave sufficient space or to be bent together with the housing parts, which can lead to problems with the functioning of the devices (e.g. the action of force on a component can cause a fracture of the conductor track or of a soldered joint).

The object of the invention is to avoid the disadvantages referred to hereinabove and in particular to specify an efficient option for a housing comprising a first housing part which engages in a catching manner with a second housing part.

This object is achieved according to the features of the independent claims. Developments of the invention will also emerge from the dependent claims.

To achieve the object, a housing for accommodating a circuit board is proposed
comprising a first housing part having a first floor and a first side wall;
comprising a second housing part having a second floor and a second side wall;
wherein the first housing part comprises a catch protrusion in an area of at least one corner, said protrusion protruding past the first side wall;
wherein the second housing part comprises a catch recess in the area of at least one corner.

‘Circuit board’ here designates any carrier element for electrical or other components. In particular, the circuit board may be a printed circuit board e.g. for an electronic circuit.

A side wall may in particular be embodied circumferentially as a single piece. The side wall may, however, also have several side-wall sections, possibly separate from one another.

It is particularly advantageous here for the catch or closure mechanism to be positionable at a point that is non-critical for the circuit board and such that, when the housing parts are joined together, no forces act on the circuit board. This type of catch also makes it possible to achieve efficient utilization of the installation space provided in the housing. This enables minimal housing dimensions and thus resource-efficient and cost-effective production.

In particular, the catch protrusion and the catch recess are arranged in a different plane from the circuit board. It is advantageous here if the catch mechanism comprising catch protrusion and catch recess is independent of the circuit board and possible components of the board: in this way, it is possible for the housing parts to be joined together without any force being exerted on the circuit board.

In particular, the circuit board itself can be populated to the edge thereof with components (e.g. high-profile electrolytic capacitors) and the catch mechanism needs no additional installation space inside the housing, e.g. through appropriate bending of the housing parts prior to the fixing thereof. Advantageously, when the housing parts are assembled, no force which could lead e.g. to conductor tracks on the circuit board becoming detached is correspondingly exerted on the components arranged on the edge of the circuit board.

In one development, the catch protrusion is integrated with the first side wall as a single piece.

In another development, the respective side wall is arranged at least partially circumferentially around the respective floor.

In one development in particular, the catch protrusion engages in a catching manner with the catch recess when the housing parts are assembled.

In one development, moreover, in areas of opposing corners, the first housing part has one catch protrusion and the second housing part has one (associated or corresponding) catch recess respectively.

In one development, furthermore, the circuit board is a circuit board populated with components.

In particular, the circuit board comprises a circuit for controlling a lamp and/or a lighting means. For example, the circuit comprises an electronic ballast.

In the context of an additional development, a substantially circular inwardly curved side wall is provided in the area of at least one corner of the housing.

A next development consists in the fact that the first floor or the second floor has an assembly guide in the area of the corner.

The assembly guide can be embodied for accepting a fastening means. For example, the housing can be fastened by means of the assembly guide.

In one configuration, at least one side wall is of increased height in sections.

An alternative embodiment consists in the fact that the at least one side wall assigned to the side wall which is of increased height in sections is correspondingly of decreased height in sections.

In a next configuration, the at least one side wall has a wall thickness in the range from 0.5 mm to 2 mm.

In particular, the respective side wall can have a wall thickness in a range from 0.65 mm to 1.5 mm.

In one configuration, the housing is made at least partially of Tarolon.

In particular, the housing can be made at least partially of plastic.

A development consists in the fact that the first housing part and the second housing part are embodied such that they can engage fittingly with one another.

The object stated hereinabove is also achieved in a method for assembling a housing as described herein, in which the two housing parts are joined together in a substantially straight manner.

In particular, the two housing parts are pressed together. In the assembly process, the housing parts can be placed, put or pressed straight onto one another. For example, an assembly guide is provided which enables a catching of the at least one catch protrusion with the at least one catch recess.

Furthermore, the object stated hereinabove is achieved in an assembly device for assembling the housing, in particular the housing parts.

Exemplary embodiments of the invention are shown and explained hereinbelow with the aid of the drawings, in which:

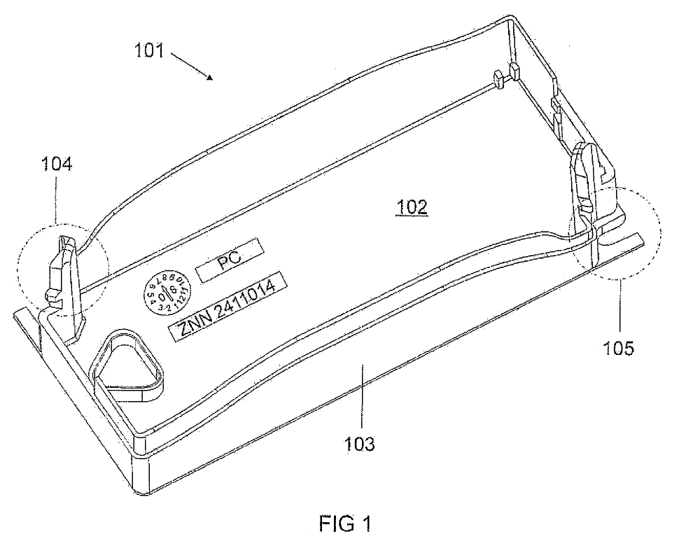

FIG. 1 shows a first housing part in an isometric representation;

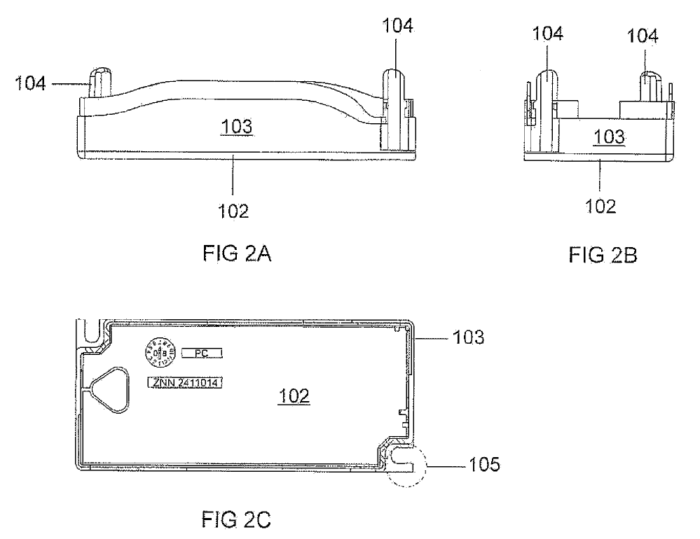

FIG. 2A shows a first side view of the first housing part;

FIG. 2B shows a second side view of the first housing part;

FIG. 2C shows a plan view of the interior of the first housing part;

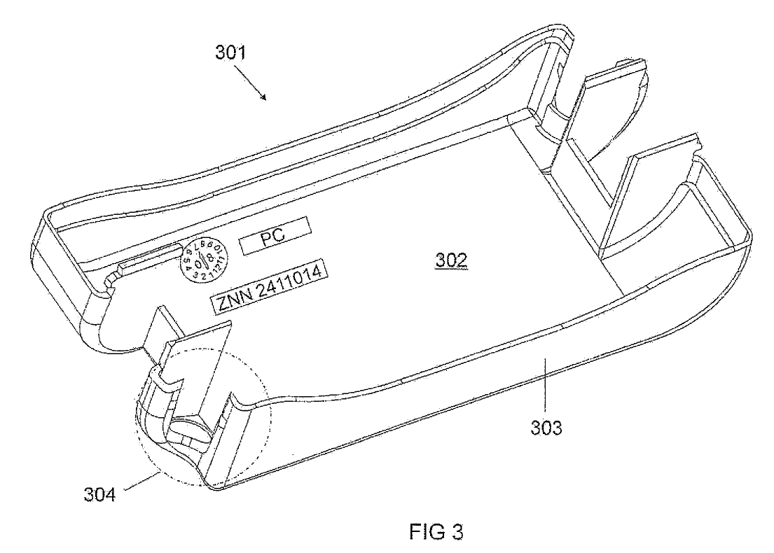

FIG. 3 shows a second housing part in an isometric representation;

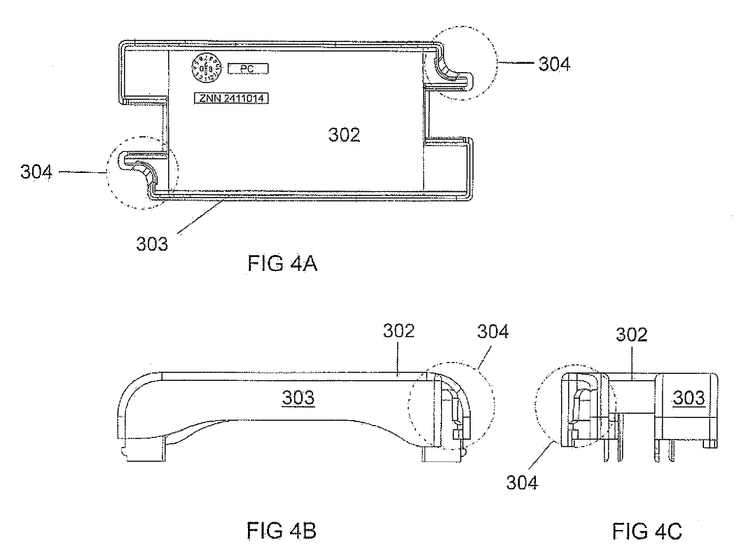

FIG. 4A shows a plan view of the interior of the second housing part;

FIG. 4B shows a first side view of the second housing part;

FIG. 4C shows a second side view of the second housing part;

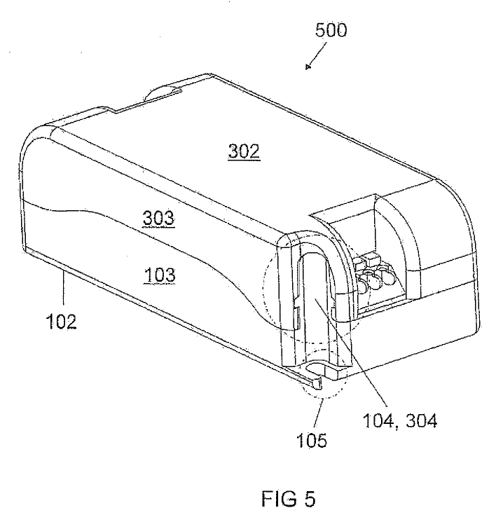

FIG. 5 shows an isometric representation of the assembled housing comprising the first housing part and the second housing part.

A housing and the components of the housing are shown by way of example hereinbelow.

FIG. 1 shows a first housing part 101 comprising a floor 102, a circumferential side wall 103 and two catch protrusions 104 in diagonally opposing corners of the housing part 101.

Furthermore, FIG. 1 shows an assembly guide 105 for fastening the first housing part 101 (or the fully assembled housing) on a carrier (not shown). A fastening of this type can be achieved e.g. by means of a screw connection on the carrier.

FIG. 2A shows a side view of the longitudinal side of the first housing part 101, FIG. 2B shows a side view of the transverse side of the first housing part 101 and FIG. 2C shows a plan view of the first housing part 101.

FIG. 3 shows a second housing part 301 comprising a floor 302, a circumferential side wall 303 and two catch protrusions 304 in diagonally opposing corners of the second housing part 301.

The catch recesses 304 are provided for engaging with the catch protrusions 104 as shown in FIG. 1 and FIGS. 2A to 2C.

FIG. 4A shows a view into the second housing part 301, FIG. 4B shows a side view of the longitudinal side of the second housing part 301 and FIG. 4C shows a side view of the transverse side of the second housing part 301.

FIG. 5 shows an isometric representation of a housing 500 comprising the first housing part 101 and the second housing part 301. It is shown how, in the assembled state, the catch protrusion 104 engages with the catch recess 304. The first housing part 101 is preferably not detachably connected to the second housing part 301. Alternatively, the housing parts 101, 301 can also be detachably connected to one another.

### List of Reference Characters

101 first housing part
102 floor (of the first housing part)
103 side wall (of the first housing part)
104 catch protrusion (of the first housing part)
105 assembly guide (of the first housing part)
301 second housing part
302 floor (of the second housing part)
303 side wall (of the second housing part)
304 catch recess (of the second housing part)
500 housing

1. A housing for accommodating a circuit board,
comprising a first housing part having a first floor and a first side wall;
comprising a second housing part having a second floor and a second side wall;
wherein the first housing part has a catch protrusion in an area of at least one corner, said protrusion protruding past the first side wall;
wherein the second housing part has a catch recess in the area of at least one corner.

2. The housing as claimed in claim 1, wherein the catch protrusion is integrated with the first side wall as a single piece.

3. The housing as claimed in claim 1, wherein the respective side wall is arranged at least partially circumferentially around the respective floor.

4. The housing as claimed in claim 1 wherein, when the housing parts are assembled, the catch protrusion engages in a catching manner with the catch recess.

5. The housing as claimed in claim 1, wherein in areas of opposite corners the first housing part has one catch protrusion and the second housing part has one catch recess respectively.

6. The housing as claimed in claim 1, wherein the circuit board is a circuit board populated with components.

7. The housing as claimed in claim 1, wherein in the area of at least one corner of the housing a substantially circular inwardly curved side wall is provided.

8. The housing as claimed in claim 7, wherein the first floor or the second floor has an assembly guide in the area of the corner.

9. The housing as claimed in claim 1, wherein at least one side wall is of increased height in sections.

10. The housing as claimed in claim 9, wherein the at least one side wall assigned to the side wall which is of increased height in sections is correspondingly of decreased height in sections.

11. The housing as claimed in claim 1, wherein the at least one side wall has a wall thickness in a range from 0.5 mm to 2 mm.

12. The housing as claimed in claim 1, wherein the housing is made at least partially of Tarolon.

13. The housing as claimed in claim 1, wherein the first housing part and the second housing part are embodied such that they can engage fittingly with one another.

14. A method for assembling a housing as claimed in claim 1, wherein the two housing parts are joined together in a substantially straight manner.

15. An assembly device for assembling the housing as claimed in claim 1.
